(19) United States
(12) Patent Application Publication
(10) Pub. No.: US 2026/0072553 A1
(43) Pub. Date: Mar. 12, 2026

(54) THREE-DIMENSIONAL CURVED SURFACE CAPACITIVE SENSORS AND WEAVING METHODS THEREOF

(71) Applicant: Centre for Perceptual and Interactive Intelligence (CPII) Ltd, Hong Kong (HK)

(72) Inventors: Yeung YAM, Hong Kong (HK); Changling Charlie WANG, Wilmslow (GB); Xiangjia CHEN, Hong Kong (HK); Chengkai DAI, Hong Kong (HK); Chun Ping LAM, Hong Kong (HK); Binzhi SUN, Hong Kong (HK)

(21) Appl. No.: 18/888,664

(22) Filed: Sep. 18, 2024

(30) Foreign Application Priority Data
Sep. 9, 2024 (HK) 32024096535.2

(51) Int. Cl. G06F 3/044; G06F 3/041

(52) U.S. Cl. CPC G06F 3/0446; G06F 3/04146; G06F 2203/04101; G06F 2203/04105

(57) ABSTRACT

The present application relates to a three-dimensional curved capacitive sensor and its weaving method. The weaving method includes: modeling a shape of the three-dimensional curved capacitive sensor into a three-dimensional curved surface mesh; converting the three-dimensional curved surface mesh into weaving information readable; generating control commands from the weaving information to weave the three-dimensional curved capacitive sensor using conductive warp threads and conductive weft threads; forming a driving channel and a sensing channel. The driving and sensing channels intersect and overlap to form capacitive nodes to form parasitic capacitance with a biological body to detect proximity. This weaving method allows the capacitive sensor to accurately conform to the target surface, achieving precise mapping of the sensing signals in three-dimensional space.

### TECHNICAL FIELD

The present disclosure relates to a field of sensors, and in particular to three-dimensional curved surface capacitive sensors and weaving methods of the three-dimensional curved surface capacitive sensors.

### BACKGROUND

Biological proximity sensors and pressure sensors are increasingly being applied in the field of human-machine interaction. In particular, in technical fields such as biomedicine and sports monitoring, there is a growing demand for real-time monitoring of biological proximity, detecting surface pressure on sensors, and quantifying the magnitude of the applied force.

Traditional biological proximity sensors and pressure sensors are typically designed and manufactured separately. Proximity sensors are primarily used to detect the distance of biological objects, while pressure sensors measure the pressure values on the sensor surface. However, this separate design increases the size of the sensors and complicates their structure. Such sensors are prone to damage when twisted or pulled, making them unsuitable for applications requiring large-area sensor coverage or for use in flexible wearable devices.

Additionally, conventional sensor products are generally structured in two-dimensional planes, making them difficult to precisely lay out on complex three-dimensional free-form surfaces and unable to achieve signal sensing arrays distributed over such surfaces.

### SUMMARY

Accordingly, it is necessary to provide a three-dimensional curved capacitive sensor and its weaving method that are resistant to damage from twisting or pulling and capable of integrating biological proximity detection and pressure detection functions.

A method for weaving a three-dimensional curved capacitive sensor comprising following steps:
modelling a shape of the three-dimensional curved capacitive sensor into a three-dimensional curved surface mesh;
converting the three-dimensional curved surface mesh into weaving information readable by a weaving device;
generating control commands from the weaving information to weave the three-dimensional curved capacitive sensor using conductive warp threads and conductive weft threads; the conductive warp threads and the conductive weft threads each include a bendable wire core and an insulating layer wrapping around the wire core, with the insulating layer made of a deformable elastic material; and
forming a driving channel by connecting one or multiple the conductive warp threads in parallel and forming a sensing channel by connecting one or multiple the conductive weft threads in parallel; the driving channels and the sensing channels intersect and overlap to form capacitive nodes; the capacitive nodes are configured to form parasitic capacitance with a biological body to detect proximity; and the capacitive nodes are configured to detect pressure values when the insulating layer deforms due to pressure.

In an embodiment, the step of converting the three-dimensional curved surface mesh into weaving information readable by a weaving device comprises:
setting a weaving start point on the three-dimensional curved surface mesh;
generating a scalar field based on a geodesic distance of all positions on the three-dimensional curved surface mesh relative to the weaving start point;
extracting contour lines from the scalar field according to a predefined interval; and
reconstructing the three-dimensional curved surface mesh using the contour lines as the positions for inserting the conductive warp threads to generate a weavable quadrilateral mesh; warp and weft threads of the weavable quadrilateral mesh are continuous; the weaving information is the weavable quadrilateral mesh.

In an embodiment, in the step generating a scalar field based on a geodesic distance of all positions on the three-dimensional curved surface mesh relative to the weaving start point, the geodesic distances are obtained using Dijkstra's algorithm, thereby generating the scalar field that is continuously diffused.

In an embodiment, the three-dimensional curved surface mesh is a mesh file constructed using triangular facets.

In an embodiment, the step of converting the three-dimensional curved surface mesh into weaving information readable by a weaving device comprises:
decomposing the three-dimensional surface mesh into a two-dimensional weaving map A;
doubling rows of the weaving map A and then keeping continuity by adding or removing grids at corners to form a weaving map B;
generating weaving map C from the weaving map B to illustrate feed rate of warp threads; and
generating weaving map D from the weaving map B to illustrate a jacquard device to select warp threads to raise;
wherein the weaving information includes weaving map C and weaving map D.

In an embodiment, the step of generating weaving map C from the weaving map B to illustrate feed rate of warp threads comprises:
transferring the weaving map B from bottom to top by taking last row as a reference; a value W stands for state for each grid in the weaving map C, W=1 represents filled state, W<1 represents empty state; if corresponding grid in the weaving map B is empty, grid in the weaving map C will be empty and W is −1; if grid in reference row is empty, fabric will shrink to vanish gap produced after adjustment of weft threads length; S represents a length of shrink, S=1−W, and all value of grids in same row pulse S.

In an embodiment, the control command comprises:
an initial command to move components of a weaving device to pre-set position;
a roller command to control a roller matrix according to the weaving map C;
a jacquard command to control a jacquard device according to the weaving map D;
a weaving command to control the weaving device to carry a conductive weft thread into a shed formed by the jacquard device and weave the conductive weft thread on conductive warp threads; and
an ending command to control the roller matrix release warp threads for a pre-set length.

In an embodiment, the three-dimensional curved surface mesh has uniform mesh units; a length of each unit is equal to a gap between neighbouring warp threads, a width of each unit is equal to a gap between neighbouring weft threads.

A three-dimensional curved capacitive sensor, the three-dimensional curved capacitive sensor is woven according to any one of the methods for weaving a three-dimensional curved capacitive sensor; the three-dimensional curved capacitive sensor comprises the driving channel and the sensing channel; the driving channel comprises one or more parallel-connected conductive warp threads; the sensing channel includes one or more parallel-connected conductive weft threads;
wherein the conductive warp threads and the conductive weft threads each include a bendable wire core and an insulating layer wrapping around the wire core, with the insulating layer made of a deformable elastic material; the conductive warp threads and the conductive weft threads form a three-dimensional curved structure using a three-dimensional curved surface weaving method;
the driving channels and the sensing channels intersect and overlap to form capacitive nodes; the capacitive nodes are configured to form parasitic capacitance with a biological body to detect proximity; and the capacitive nodes are also configured to detect pressure values when the insulating layer deforms due to pressure.

In one embodiment, a number of conductive warp threads in each of the driving channels is equal;
and/or, a number of conductive weft threads in each of the sensing channels is equal.

In an embodiment, the conductive warp threads are replaceable structures; and/or the conductive weft threads are replaceable structures.

In an embodiment, a material of the insulating layer is silicone or polytetrafluoroethylene.

In one embodiment, further comprising an integrated chip; the driving channels and the sensing channels are respectively communicatively connected to the integrated chip.

The above three-dimensional curved capacitive sensor and its weaving method involve the conductive warp threads and conductive weft threads which form a three-dimensional curved structure by a three-dimensional curved weaving method. This results in a simple yet robust structure. The capacitive sensor is resistant to damage from twisting or pulling, making it suitable for large-area coverage scenarios and applying to flexible wearable devices. The three-dimensional curved capacitive sensor can precisely cover the target being detected, with sensor signals distributed in an array, allowing for accurate detection. The weaving method enables the capacitive sensor to conform precisely to the target's curved surface, achieving precise mapping of sensor signals in three-dimensional space. The control commands generated in the weaving method facilitate rational planning of the weaving path, ensuring that the distribution of the conductive weft threads maintains continuity while also guaranteeing uniform distribution of each sensing unit.

### BRIEF DESCRIPTION OF THE DRAWINGS

In order to better illustrate the embodiments of the present invention or the prior art, the accompanying drawings used in the description of the embodiments or the prior art will be briefly introduced below. It is apparent that the drawings described below represent only some embodiments of the present invention. For those skilled in the art, additional drawings of other embodiments may be derived from these drawings without involving any inventive effort.

FIG. 1 is a schematic diagram of a three-dimensional curved capacitive sensor according to one embodiment;

FIG. 2 is a cross-sectional view of the conductive warp threads and conductive weft threads of the three-dimensional curved capacitive sensor shown in FIG. 1;

FIG. 3 is a schematic diagram of a flexible wearable device according to one embodiment;

FIG. 4 is a flowchart of the weaving method for a three-dimensional curved capacitive sensor according to one embodiment;

FIG. 5 is a schematic diagram of a three-dimensional curved surface mesh in one embodiment of the weaving method shown in FIG. 4;

FIG. 6 is a flowchart of step S340 in one embodiment of the weaving method shown in FIG. 4;

FIG. 7 is a schematic diagram of a target three-dimensional object in one embodiment of the weaving method shown in FIG. 4;

FIG. 8 is a schematic diagram of weaving map A in the weaving method shown in FIG. 7;

FIG. 9 is a schematic diagram of weaving map B in the weaving method shown in FIG. 7;

FIG. 10 is a schematic diagram of weaving map C in the weaving method shown in FIG. 7;

FIG. 11 is a schematic diagram of weaving map D in the weaving method shown in FIG. 7;

FIG. 12 is a flowchart of step S340 in another embodiment of the weaving method shown in FIG. 4;

FIG. 13 is a schematic diagram of the scalar field of the three-dimensional curved surface mesh in one embodiment of the weaving method shown in FIG. 12;

FIG. 14 is a schematic diagram of the weavable quadrilateral mesh in the weaving method shown in FIG. 13;

FIG. 15 is a physical diagram of the three-dimensional curved capacitive sensor woven according to the weaving method shown in FIG. 14.

### DETAILED DESCRIPTION OF THE EMBODIMENTS

In order to facilitate the understanding of the present disclosure, a more comprehensive description of the three-dimensional curved capacitive sensor and its weaving method will be provided below with reference to the relevant drawings. The drawings present preferred embodiments of the three-dimensional curved capacitive sensor and its weaving method. However, the three-dimensional curved capacitive sensor and its weaving method can be implemented in many different forms and are not limited to the embodiments described herein. Rather, the provision of these embodiments aims to make the disclosure of the three-dimensional curved capacitive sensor and its weaving method more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

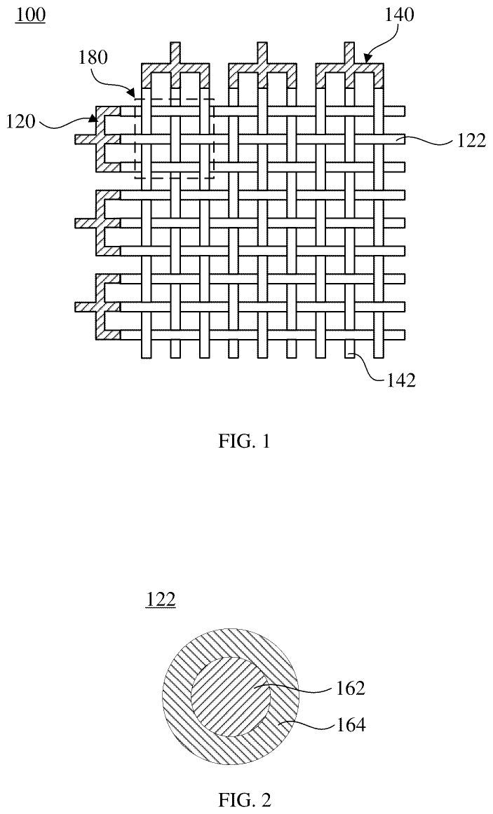

As shown in FIG. 1, a three-dimensional curved capacitive sensor 100 includes a driving channel 120 and a sensing channel 140 in one embodiment. The driving channel 120 includes one or more conductive warp threads 122 connected in parallel, and the sensing channel 140 includes one or more conductive weft threads 142 connected in parallel.

Referring also to FIG. 2, the conductive warp threads 122 and the conductive weft threads 142 each include a bendable wire core 162 and an insulating layer 164 that wraps around the wire core 162, with the insulating layer 164 made of a deformable elastic material. The conductive warp threads 122 and the conductive weft threads 142 form a three-dimensional curved structure using a three-dimensional weaving method. The driving channel 120 and the sensing channel 140 intersect and overlap to form capacitive nodes 180. The capacitive nodes 180 are configured to form parasitic capacitance with a biological body to detect proximity, and they are also used to detect pressure values when the insulating layer 164 deforms due to pressure. By calibrating the static capacitance value and comparing the static capacitance value with the real-time capacitance value, it can be determined whether there is biological proximity or an external force applied. The capacitive sensor 100 with a three-dimensional curved structure can precisely cover the target being detected, and the sensing signals can be distributed in an array, allowing for accurate detection.

Specifically, each sensing channel 140 and driving channel 120 are insulated from each other, and the capacitive effect is created due to the mutual insulation and interwoven structure. That is to say, the driving channel 120 acts as the positive electrode and the sensing channel 140 as the negative electrode, forming capacitive nodes 180. These capacitive nodes 180 can form parasitic capacitance with a biological body to detect proximity. When a biological entity, such as a human hand, approaches, parasitic capacitance is generated between the biological entity and the conductive weft threads 142. This capacitance diverts charge from the capacitive nodes 180, resulting in a decrease in the capacitance value detected by the chip.

Additionally, the capacitive nodes 180 are used to detect pressure values when the insulating layer 164 deforms due to pressure. When an external force is applied to the surface of the capacitive sensor 100, the insulating layer 164, which wraps around the conductive warp threads 122 and conductive weft threads 142, deforms due to its elasticity. This deformation decreases the distance between the plates of the capacitive nodes 180, leading to an increase in capacitance value and thus allowing for the detection of pressure magnitude.

In one embodiment, both the conductive warp threads 122 and the conductive weft threads 142 can be replaceable structures. Since the conductive warp threads 122 and conductive weft threads 142 are connected through weaving, no additional fixed connection structures are required, allowing for replacement. If any part of the conductive warp threads 122 or conductive weft threads 142 is damaged, only the damaged sections need to be replaced, rather than the entire structure. This approach can reduce costs during maintenance.

The material of the insulating layer 164 is a deformable elastic material. In this specific embodiment, the material of the insulating layer 164 is silicone. The silicone casing allows the conductive warp threads 122 and the conductive weft threads 142 to become fine and flexible wires, making them suitable as weaving materials. In another embodiment, the material of the insulating layer 164 can be other insulating materials such as polytetrafluoroethylene, which can be the polytetrafluoroethylene material known under the trademark Teflon. Different materials exhibit different elastic properties; the harder the material, the lower the sensitivity to force detection but the greater the measurement range. In other embodiments, the material of the insulating layer 164 can also be rubber or thermoplastic elastomers with similar hardness, resilience, and insulating properties.

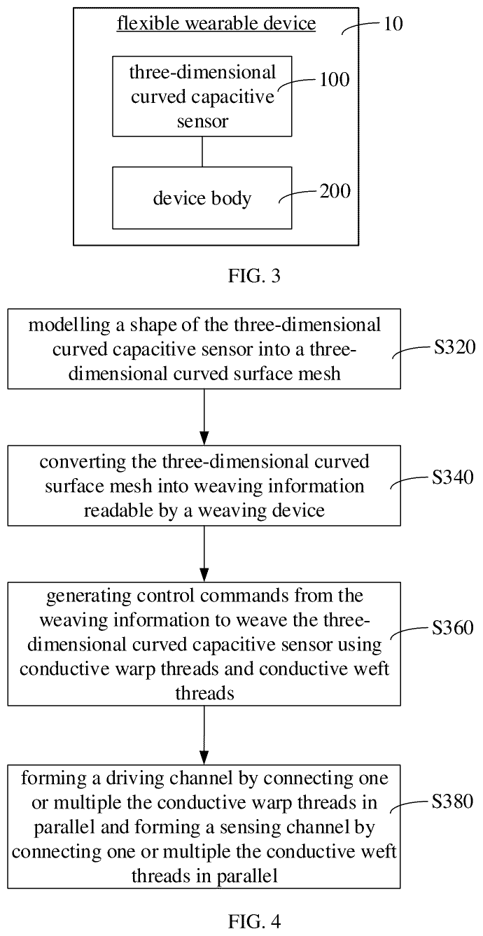

Referring to FIG. 3, in one embodiment, the number of conductive warp threads 122 in each driving channel 120 can be equal, and the number of conductive weft threads 142 in each sensing channel 140 can also be equal. The conductive warp threads 122 are evenly divided into several channels, with each sensing channel 140 containing the same number of conductive warp threads 122. Subsequently, during the weaving process of the conductive weft threads 142, a driving channel 120 is formed after weaving a certain number of threads. The length and width of each channel are determined by the number of conductive warp threads 122 or conductive weft threads 142 in that channel, thereby creating a perpendicular intersecting sensing grid. Maintaining the same number of conductive warp threads 122 and/or conductive weft threads 142 ensures uniform sensor density throughout the structure. However, for specific needs, such as areas requiring high-density sensing, fewer conductive warp threads 122 and/or conductive weft threads 142 can be used. This allows for the creation of more driving channels 120 and/or sensing channels 140, resulting in higher resolution data. In other embodiments, the number of conductive warp threads 122 in each driving channel 120 may not be equal, and the number of conductive weft threads 142 in each sensing channel 140 may also not be equal.

In general, the number of conductive warp threads 122 in each driving channel 120 and the number of conductive weft threads 142 in each sensing channel 140 are multiple. In the embodiment shown in FIG. 1, this number is three. In other embodiments, it may range from 2 to 6. In one embodiment, the number also can be one. In this case, the size limitation of the detection density is determined by the size of a single conductive warp thread 122 and/or conductive weft thread 142.

Specifically, referring to FIG. 1, in one embodiment, two neighbouring conductive warp threads 122 are respectively located on two sides of the same conductive weft thread 142, and two neighbouring conductive weft threads 142 are respectively located on two sides of the same conductive warp thread 122, forming a regular and uniform grid pattern. The consistent structure at each intersection ensures more accurate measurements. In one embodiment, the conductive warp threads 122 and conductive weft threads 142 are woven together using a plain weave. In a plain weave, the conductive warp threads 122 and conductive weft threads 142 have the most interlacing points, with many bends in the yarns, resulting in a flat fabric surface, a sturdy and well-defined form, a firm texture and a compact appearance, with excellent structural strength. In other embodiments, the organizational form of the conductive warp threads 122 and conductive weft threads 142 also can be twill weave or satin weave.

In one embodiment, the capacitive sensor 100 can also include an integrated chip, with the driving channels 120 and the sensing channels 140 communicatively connected to the integrated chip. The integrated chip scans each capacitive node 180 and calculates the capacitance values. In other embodiments, the capacitive sensor 100 can also be combined with an external chip to achieve the purpose of scanning the capacitive nodes 180.

Referring to FIG. 3, the embodiment of the present application also provides a flexible wearable device 10. This flexible wearable device 10 includes a device body 200 and the capacitive sensor 100 from the aforementioned embodiment. The capacitive sensor 100 is arranged on the device body 200 and is communicatively connected to the device body 200. The flexible wearable device 10 can be a headband, wristband, vest, or other wearable devices.

The design of the woven structure enables the capacitive sensor 100 to possess flexibility and wearability, allowing it to conform to various body parts and movements. The three-dimensional curved capacitive sensor 100 can accurately cover the target being detected. The sensor 100 detects the proximity of a biological entity by measuring changes in capacitance and converts this into proximity distance data. The sensing signals can be distributed in an array, ensuring precise detection. Additionally, the woven structure allows the sensor to sensitively detect forces applied to its surface and quantify their magnitude. The capacitive sensor 100 can be integrated with existing electronic devices and systems for real-time monitoring and data transmission, making it suitable for a wide range of applications in fields such as biomedicine, sports analysis, and human-computer interaction. In the aforementioned embodiments, the sensor can also be applied to the surfaces of industrial machinery, such as robotic arms, adding an extra dimension of sensory capability and enabling human-machine interaction in smart industrial environments.

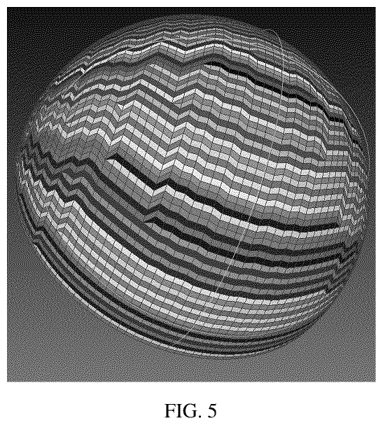

Refer to FIG. 4. The embodiment of this application also provides a method for weaving the three-dimensional curved capacitive sensor 100. The weaving method includes the following steps:
S320: modelling a shape of the three-dimensional curved capacitive sensor 100 into a three-dimensional curved surface mesh.
S340: converting the three-dimensional curved surface mesh into weaving information readable by a weaving device.
S360: generating control commands from the weaving information to weave the three-dimensional curved capacitive sensor 100 using conductive warp threads 122 and conductive weft threads 142.

The conductive warp threads 122 and conductive weft threads 142 each include a bendable wire core 162 and an insulating layer 164 wrapping around the wire core 162, with the insulating layer 164 made of a deformable elastic material.

In one embodiment, the control commands may include an initial command, a roller command, a jacquard command, a weaving command, and an ending command. The initial command is configured to move the components of the weaving device to a pre-set position. The roller command is configured to control a roller matrix according to the weaving map C. The jacquard command is configured to control a jacquard device according to the weaving map D. The weaving command is configured to control the weaving device to carry the conductive weft threads 142 into a shed formed by the jacquard device and weave the conductive weft threads 142 on the conductive warp threads 122. The end command is configured to control the roller matrix to release the winding threads by a pre-set length. The control command comprises the commands required for the operational workflow of the weaving process.
S380: forming a driving channel 120 by connecting one or multiple the conductive warp threads 122 in parallel and forming a sensing channel 140 by connecting one or multiple the conductive weft threads 142 in parallel.

The driving channel 120 and the sensing channel 140 intersect and overlap to form capacitive nodes 180. The capacitive nodes 180 are configured to form parasitic capacitance with a biological body to detect the proximity of the biological body. Additionally, the capacitive nodes 180 are configured to detect pressure values when the insulating layer 164 deforms due to pressure.

The step S320 provides a mesh processing strategy to rebuild the desired 3D mesh into the three-dimensional surface mesh. The desired 3D mesh is an input of this method, and the three-dimensional surface mesh is an available mesh for the following processes. In an embodiment, each unit of the three-dimensional surface mesh is the same size. The step of S340 provides a weaving map extraction method. To satisfy constraint of the weaving device, the weaving information will be converted to a weaving map which is between-row continuous and readable for the weaving device in the step. In the step of S360, the final control can be generated to instruct the weaving device to perform corresponding operations.

In one embodiment, referring to FIG. 5, the three-dimensional curved mesh can have uniform mesh units. The length of each mesh unit is equal to the gap between neighbouring conductive warp threads 122, and the width of each mesh unit is equal to the gap between neighbouring conductive weft threads 142. The shape of the units can be rectangular, triangular, or parallelogram. Triangular units are allowed in convergent areas.

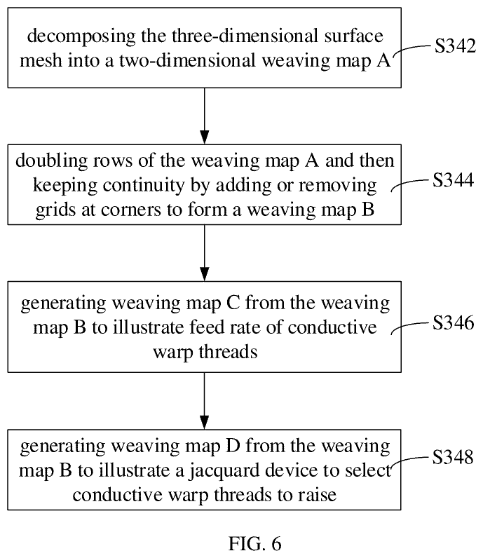

Specifically, referring to FIG. 6, in one embodiment, the step of S340 can include the following steps:
S342: decomposing the three-dimensional surface mesh into a two-dimensional weaving map A.
S344: doubling rows of the weaving map A and then keeping continuity by adding or removing grids at corners to form a weaving map B.
S346: generating weaving map C from the weaving map B to illustrate feed rate of conductive warp threads 122.
S348: generating weaving map D from the weaving map B to illustrate a jacquard device to select conductive warp threads 122 to raise.

Wherein, the weaving information includes weaving map C and weaving map D. The order of steps S346 and S348 can be reversed.

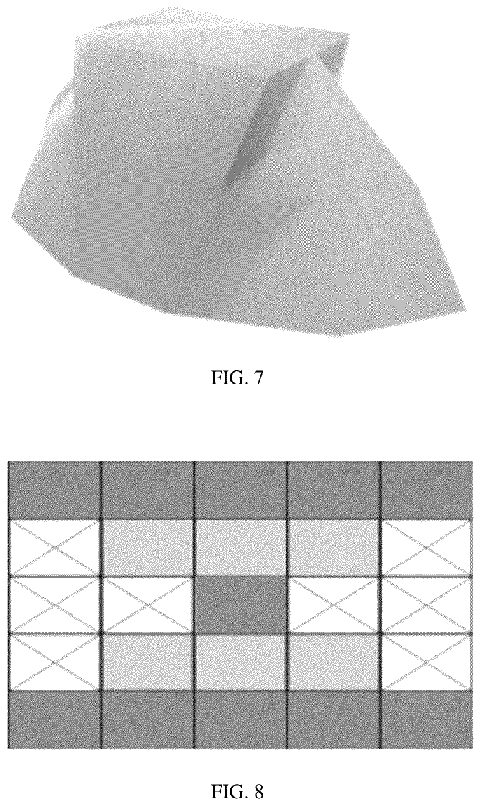

In one embodiment, the step of S340 reconstructs the target three-dimensional object shown in FIG. 7 into a three-dimensional curved mesh. FIGS. 8-11 illustrate the four weaving maps generated throughout the conversion process, representing different states, which are weaving maps A-D.

Referring to FIG. 8, in the step of S342, the three-dimensional curved mesh is decomposed into a two-dimensional weaving map A. The valid segments are marked in grey, while the invalid meshes are marked with cross symbols. The mountain-shaped three-dimensional curved surface of the mesh can be extended into a plane by cutting along the side of the surface. Based on the size of the weaving units, the plane is converted into a grid, termed weaving map A.

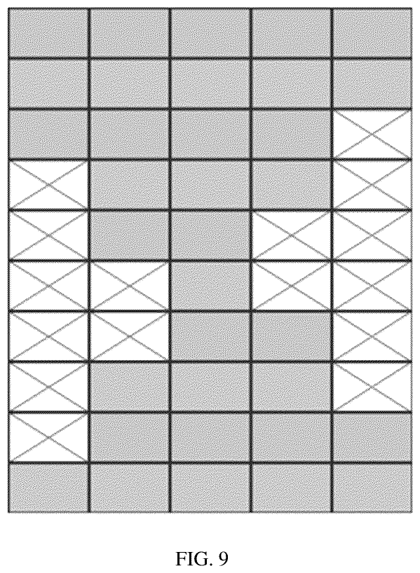

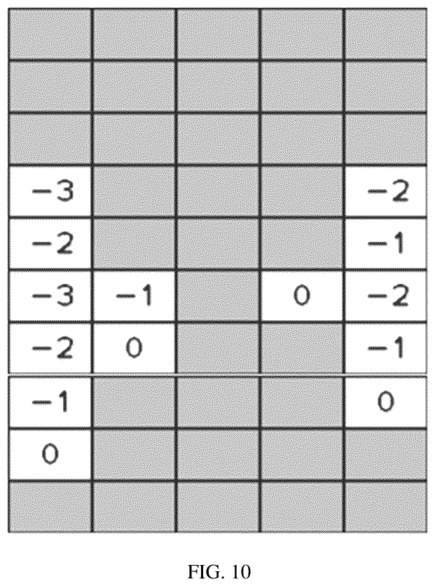

Referring to FIG. 9, in the step of S344, by considering continuity during the weaving process, each row of the weaving map is continuously divided into two rows to obtain weaving map B. To maintain row continuity across the entire weaving map, firstly, the number of rows in weaving map A is doubled. Then, grids are added or subtracted at the corners to form the new weaving map B Referring to FIG. 10, in one embodiment, in the step of S346, the weaving map B is transferred from bottom to top by taking last row as a reference; a value W stands for state for each grid in the weaving map C, W=1 represents filled state, W<1 represents empty state. If the corresponding grid in weaving map B is empty, the grid in weaving map C will also be empty, and W will be −1. If the grid in the reference row is empty, the fabric will shrink to vanish the gap produced after adjustment of the length of the conductive weft threads 142, which occurs after the adjustment of the length of the conductive warp threads 122. S represents the length of shrink, S=1−W, and all values of grids in the same row will pulse S. The weaving map C generated from weaving map B represents the feed rate of the conductive warp threads 122. Gray stitches are valid (+1), while other stitches are invalid, with corresponding negative values.

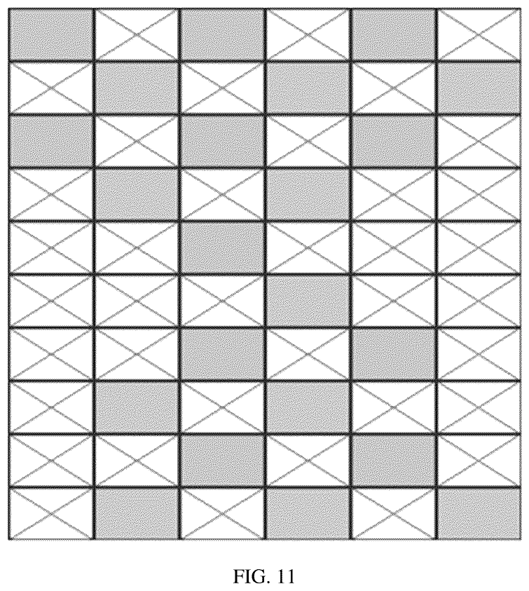

Referring to FIG. 11, weaving map D is generated from weaving map B by adding a column on the right side to make the neighbouring stitch invalid for weaving. The purpose of generating weaving map D is to ensure that the jacquard machine of the weaving device can correctly select the jacquard threads. One column corresponds to two neighbouring conductive warp threads 122. For a valid grid, one of the two neighbouring conductive warp threads 122 is raised to form a shed, while for an invalid grid, both neighbouring conductive warp threads 122 should be lowered. Therefore, weaving map D includes an additional column, where each column corresponds to a conductive warp thread 122. For valid grids, one neighbouring conductive warp threads 122 is raised, while for invalid grids, both neighbouring conductive warp threads 122 are lowered during the conversion from weaving map B to weaving map D. The described weaving method enables the capacitive sensor 100 to accurately conform to the target's curved surface, achieving precise mapping of the sensing signals in three-dimensional space. The control commands generated by this weaving method ensure a reasonable weaving path planning, enabling the distribution of the conductive weft threads 142 to meet both the continuity of weaving and the even distribution of each sensing unit.

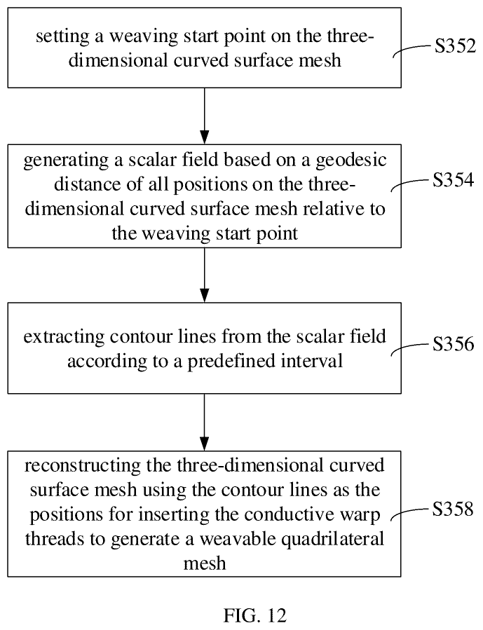

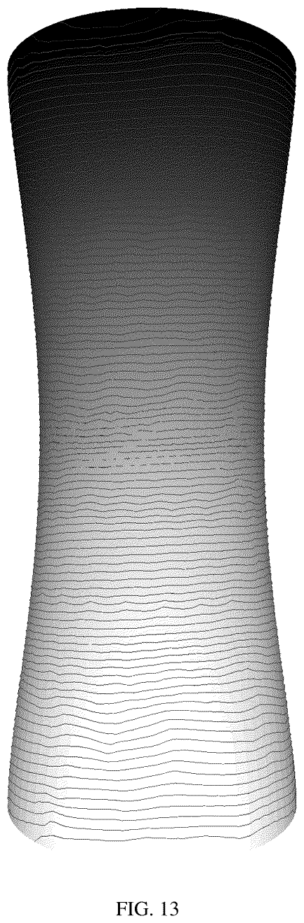

Referring to FIG. 12, in another embodiment, the weaving method for the three-dimensional curved capacitive sensor involves dimensional reduction of the three-dimensional freeform surface to obtain a two-dimensional weaving path. This technique has been further optimized in this embodiment to achieve a weaving path that both ensures weaving continuity and guarantees an even distribution of each sensing unit, thereby enabling the fabrication of a flexible sensor array that can cover a three-dimensional freeform surface. Specifically, in this embodiment, the step of S340 includes the following steps:
S352: setting a weaving start point on the three-dimensional curved surface mesh. One mesh with boundaries generally has some edges, which can be used as the starting point in some embodiments. Referring to FIG. 13, in one embodiment, the weaving starting point is at the bottom edge of the cylindrical shape shown in the figure. The shape of the modelled three-dimensional curved capacitive sensor can be a cylindrical surface with thin middle and thick ends as shown in FIG. 13, or any other surface with boundaries.
S354: generating a scalar field based on a geodesic distance of all positions on the three-dimensional curved surface mesh relative to the weaving start point. A schematic diagram of the scalar field is shown in FIG. 13. The scalar field represents a geodesic distance field that marks the shortest path from each point on the surface to the starting point. In one embodiment, the geodesic distance of all positions on the three-dimensional curved mesh relative to the weaving starting point can be obtained using Dijkstra's algorithm, resulting in a continuously diffusing scalar field.
S356: extracting contour lines from the scalar field according to a predefined interval. After normalization, the mesh can be divided into several parts and contour lines extracted by determining the interval. For example, using an interval of 0.1 yields 10 segments and 11 contour lines.
S358: reconstructing the three-dimensional curved surface mesh using the contour lines as the positions for inserting the conductive warp threads to generate a weavable quadrilateral mesh. In this mesh, both the warp and weft threads of the weavable quadrilateral mesh are continuous. The weaving information in this embodiment is thus a weavable quadrilateral mesh.

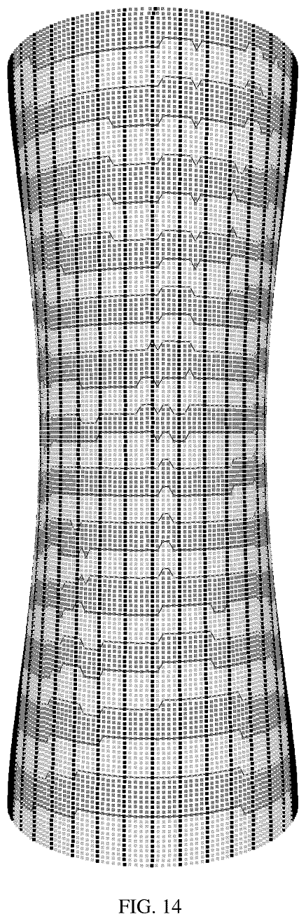

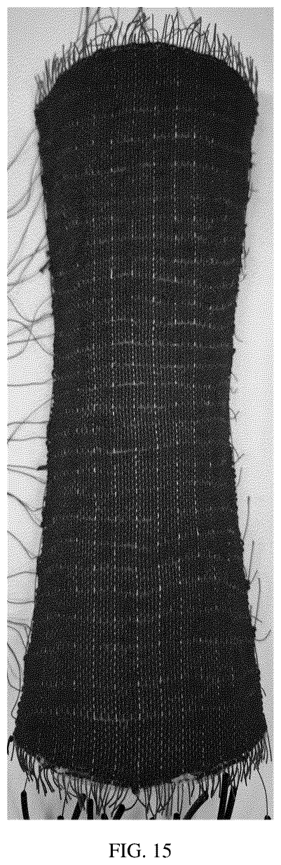

The weavable quadrilateral mesh is weavable, specifically meaning that the weft threads can start from one point (e.g., the bottom left corner in FIG. 14) and, by continuously interlacing to the other end, a single thread can traverse the entire mesh, akin to the principle of drawing a continuous line.

In one embodiment, the fabric of the three-dimensional curved capacitive sensor can also include normal yarns. The contour lines can be used as the positions for inserting conductive warp threads, and the distribution of standard weft threads between each contour line can be planned to achieve uniform distribution of the conductive channels. Referring to FIG. 14, in this embodiment, the contour lines are horizontal lines, and the weavable quadrilateral mesh is represented as a dense grid in the figure.

In one embodiment, the three-dimensional curved surface mesh can be a triangular mesh file constructed from triangular facets. This topology provides information about vertices, edges, and faces, with the points on the mesh serving as carriers of the geodesic field values, each point having a set of values. Since the geodesic field records the shortest paths, the mesh can be divided into strips of uniform width based on the segmentation of the geodesic field.

The weavable quadrilateral mesh is quadrilateral. After extracting the geodesic field from the triangular mesh, the triangular mesh is reconstructed into a quadrilateral mesh. The advantage of this mesh is that it can correspond one-to-one with the weaving units (each quadrilateral represents an intersection of two warp and weft threads), allowing the weaving path of the weft threads to be obtained. Therefore, the weaving information can be the weavable quadrilateral mesh generated in the step of S358.

FIG. 15 shows a physical diagram of the three-dimensional curved capacitive sensor woven using the method described in the above embodiments. Through the improvements in steps S352-S358, each strip-shaped region is ensured to be continuously weavable. This results in a weaving path that meets both the continuity of weaving and the uniform distribution of each sensing unit, enabling the creation of a flexible sensor array that can cover a three-dimensional freeform surface.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure. Therefore, the protection scope of the disclosure is subject to the protection scope of the appended claims.

What is claimed is:

1. A method for weaving a three-dimensional curved capacitive sensor comprising following steps:
modelling a shape of the three-dimensional curved capacitive sensor into a three-dimensional curved surface mesh;
converting the three-dimensional curved surface mesh into weaving information readable by a weaving device;
generating control commands from the weaving information to weave the three-dimensional curved capacitive sensor using conductive warp threads and conductive weft threads; the conductive warp threads and the conductive weft threads each include a bendable wire core and an insulating layer wrapping around the wire core, with the insulating layer made of a deformable elastic material; and
forming a driving channel by connecting one or multiple the conductive warp threads in parallel and forming a sensing channel by connecting one or multiple the conductive weft threads in parallel; the driving channels and the sensing channels intersect and overlap to form capacitive nodes; the capacitive nodes are configured to form parasitic capacitance with a biological body to detect proximity; and the capacitive nodes are configured to detect pressure values when the insulating layer deforms due to pressure.

2. The method for weaving a three-dimensional curved capacitive sensor of claim 1, wherein the step of converting the three-dimensional curved surface mesh into weaving information readable by a weaving device comprises:
setting a weaving start point on the three-dimensional curved surface mesh;
generating a scalar field based on a geodesic distance of all positions on the three-dimensional curved surface mesh relative to the weaving start point;
extracting contour lines from the scalar field according to a predefined interval; and
reconstructing the three-dimensional curved surface mesh using the contour lines as the positions for inserting the conductive warp threads to generate a weavable quadrilateral mesh; warp and weft threads of the weavable quadrilateral mesh are continuous; the weaving information is the weavable quadrilateral mesh.

3. The method for weaving a three-dimensional curved capacitive sensor of claim 2, wherein in the step generating a scalar field based on a geodesic distance of all positions on the three-dimensional curved surface mesh relative to the weaving start point, the geodesic distances are obtained using Dijkstra's algorithm, thereby generating the scalar field that is continuously diffused.

4. The method for weaving a three-dimensional curved capacitive sensor of claim 2, wherein the three-dimensional curved surface mesh is a mesh file constructed using triangular facets.

5. The method for weaving a three-dimensional curved capacitive sensor of claim 1, wherein the step of converting the three-dimensional curved surface mesh into weaving information readable by a weaving device comprises:
decomposing the three-dimensional surface mesh into a two-dimensional weaving map A;
doubling rows of the weaving map A and then keeping continuity by adding or removing grids at corners to form a weaving map B;
generating weaving map C from the weaving map B to illustrate feed rate of warp threads; and
generating weaving map D from the weaving map B to illustrate a jacquard device to select warp threads to raise;
wherein the weaving information includes weaving map C and weaving map D.

6. The method for weaving a three-dimensional curved capacitive sensor of claim 5, wherein the step of generating weaving map C from the weaving map B to illustrate feed rate of warp threads comprises:
transferring the weaving map B from bottom to top by taking last row as a reference; a value W stands for state for each grid in the weaving map C, W=1 represents filled state, W<1 represents empty state; if corresponding grid in the weaving map B is empty, grid in the weaving map C will be empty and W is −1; if grid in reference row is empty, fabric will shrink to vanish gap produced after adjustment of weft threads length; S represents a length of shrink, S=1−W, and all value of grids in same row pulse S.

7. The method for weaving a three-dimensional curved capacitive sensor of claim 1, wherein the three-dimensional curved surface mesh has uniform mesh units; a length of each unit is equal to a gap between neighbouring warp threads, a width of each unit is equal to a gap between neighbouring weft threads.

8. A three-dimensional curved capacitive sensor, the three-dimensional curved capacitive sensor is woven according to the methods for weaving a three-dimensional curved capacitive sensor in claim 1; the three-dimensional curved capacitive sensor comprises the driving channel and the sensing channel; the driving channel comprises one or more parallel-connected conductive warp threads;
the sensing channel includes one or more parallel-connected conductive weft threads;
wherein the conductive warp threads and the conductive weft threads each include a bendable wire core and an insulating layer wrapping around the wire core, with the insulating layer made of a deformable elastic material; the conductive warp threads and the conductive weft threads form a three-dimensional curved structure using a three-dimensional curved surface weaving method;
the driving channels and the sensing channels intersect and overlap to form capacitive nodes; the capacitive nodes are configured to form parasitic capacitance with a biological body to detect proximity; and the capacitive nodes are also configured to detect pressure values when the insulating layer deforms due to pressure.

9. The three-dimensional curved capacitive sensor of claim 8, wherein the conductive warp threads are replaceable structures; and/or the conductive weft threads are replaceable structures.

10. The three-dimensional curved capacitive sensor of claim 8, wherein a material of the insulating layer is silicone or polytetrafluoroethylene.
